(19) United States
(12) Patent Application Publication
(10) Pub. No.: US 2007/0254586 A1
(43) Pub. Date: Nov. 1, 2007

(54) Apparatus and method for negotiating relay station (RS) function in multihop relay Broadband Wireless Access (BWA) communication system

(75) Inventors: Sung-Jin Lee, Seoul (KR); Jae-Weon Cho, Suwon-si (KR); Mi-Hyun Lee, Seoul (KR); Hyun-Jeong Kang, Seoul (KR); Pan-Yuh Joo, Seoul (KR); Young-Ho Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/725,586

(22) Filed: Mar. 19, 2007

(30) Foreign Application Priority Data
Mar. 17, 2006 (KR) 2006-0024609

(51) Int. Cl. H04B 7/15

(52) U.S. Cl. 455/11.1

(57) ABSTRACT

An apparatus and method for negotiating a relay service function of a relay station (RS) in a multihop relay Broadcast Wireless Access (BWA) communication system are provided. The method includes transmitting a first message containing function information supportable by an RS to a serving station, confirming the RS supportable function using the first message received from the RS, transmitting a second message containing relay service function information to be performed by the RS to the RS, and executing the relay service according to the RS service information of the second message.

### PRIORITY

This application claims priority under 35 U.S.C. § 119 to an application filed in the Korean Intellectual Property Office on Mar. 17, 2006 and assigned Serial No. 2006-24609, the contents of which are incorporated herein by reference.

### BACKGROUND OF THE INVENTION

1. Field of the Invention

The present invention relates generally to a multihop relay Broadband Wireless Access (BWA) communication system, and, in particular, to an apparatus and method for negotiating a Relay Station (RS) function in the multihop relay BWA communication system.

2. Description of the Related Art

In fourth generation (4G) communication systems, research has been conducted to provide users with various Quality of Services (QoSs) at a data rate over 100 Mbps. Specifically, research of the 4 G communication system has been conducted into the high rate service support to guarantee mobility and QoS in BWA communication systems. Representative 4 G communication systems include Institute of Electrical and Electronics Engineers (IEEE) 802.16a and 802.16e communication systems.

IEEE 802.16a and 802.16e communication systems adapt an Orthogonal Frequency Division Multiplexing (OFDM)/Orthogonal Frequency Division Multiple Access (OFDMA) scheme to support a broadband transmission network in physical channels of the Metropolitan Area Network (MAN). An IEEE 802.16a communication system does not consider the mobility of the Subscriber Station (SS), but only considers the fixed state and the single cell structure. By contrast, an IEEE 802.16e communication system addresses the mobility of the SS, which is updated from the IEEE 802.16a communication system.

FIG. 1 illustrates a conventional IEEE 802.16e communication system.

In FIG. 1, the IEEE 802.16e communication system has a multi-cell architecture, that is, a first cell 100 and a second cell 150. The IEEE 802.16e communication system includes Base Stations (BSs) 110 and 140 managing the respective cells 100 and 150, and a plurality of Mobile Stations (MSs) 111, 113, 130, 151, and 153. Signals are transmitted and received between BSs 110 and 140 and MSs 111, 113, 130, 151, and 153 using an OFDM/OFDMA scheme.

MS 130 resides in the overlapping area of the first and second cells 100 and 150, that is, in a handover region. When the MS 130 migrates to the second cell 150 while transmitting and receiving signals to and from the first BS 110, the serving BS of MS 130 is changed from the first BS 110 to the second BS 140.

By communicating through the direct links between the fixed BS and the MSs as shown in FIG. 1, the conventional IEEE 802.16e communication system can easily configure highly reliable radio communication links between the BS and the MSs. However, since the position of the BS is fixed, the IEEE 802.16e communication system is subject to the low flexibility of the radio network configuration. Thus, it is difficult to provide efficient communication services in a radio communication environment suffering severe changes of traffic distribution or traffic demand.

To overcome these shortcomings, a wireless communication system can adopt a multihop relay data delivery scheme using a Relay Station (RS) or MSs having relay capability.

Using the multihop relay scheme, the wireless communication system can reconfigure the network by promptly coping with the changes of the communication environment and utilize the entire radio network more efficiently. Also, the multihop relay wireless communication system is able to expand the cell service area and increase its system capacity. That is, in poor channel conditions between a BS and an MS, the wireless communication system can provide a better radio channel to the MS by relaying signals transmitted and received between the BS and the MS through relay links by way of the RS.

FIG. 2 illustrates a conventional broadband wireless communication system using a multihop relay scheme for the expansion of the service area.

The multihop relay wireless communication system in FIG. 2 has a multicell architecture, that is, a first cell 200 and a second cell 240. The multihop relay wireless communication system includes BSs 210 and 250 managing the respective cells 200 and 240, and a plurality of MSs 211, 213, 251, 253 and 255 within the cells 200 and 240. The wireless communication system further includes RSs 220 and 260 for providing multihop relay paths between a plurality of MSs 221, 223, 261, and 263 outside the coverage of the cells 200 and 240, and the BSs 210 and 250.

Signals are transmitted and received among BSs 210 and 250, RSs 220 and 260, and MSs 211, 213, 221, 223, 251, 253, 255, 261 and 263 using an OFDM/OFDMA scheme.

MSs 211 and 213 and the first RS 220, which belong to the first cell 200, communicate directly with the first BS 210, whereas. MSs 221 and 223 in the coverage area 230 of the first RS 220 communicate with the first BS 210 via the first RS 220. That is, the first RS 220 relays signals transmitted and received between the MSs 221 and 223 and the first BS 210.

MSs 251, 253 and 255 in the coverage of the second cell 240 and the second RS 260 communicate directly with the second BS 250, whereas MSs 261 and 263 in the coverage 270 of the second RS 260 communicate with the second BS 250 via the second RS 260. That is, the second RS 260 relays signals transmitted and received between the MSs 261 and 263 and the BS 250.

FIG. 3 illustrates a conventional broadband wireless communication system using a multihop relay scheme for increased system capacity.

The multihop relay wireless communication system in FIG. 3 includes a BS 310, MSs 311, 313, 321, 323, 331 and 333, and RSs 320 and 330. Communications between the BS 310, the RSs 320 and 330, and the MSs 311, 313, 321, 323, 331 and 333 are performed according to the OFDM/OFDMA scheme.

BS 310 manages a cell 300. MSs 311, 313, 321, 323, 331 and 333 and RSs 320 and 330, belonging to the cell 300, communicate directly with BS 310.

However, when MSs 321, 323, 331 and 333 travel close to the boundary of the cell 300, a Signal-to-Noise Ratio (SNR) between BS 310 and MSs 321, 323, 331 and 333 may be low. By relaying signals transmitted and received between the BS 310 and the MSs 321, 323, 331 and 333, RSs 320 and 330 can provide-improved channels to the MSs 321, 323, 331 and 333. That is, RSs 320 and 330 can raise the effective data rate of MSs 321, 323, 331 and 333 and increase the system capacity by providing high-speed data delivery paths to the MSs 321, 323, 331 and 333.

As discussed above, the RS can serve to extend the service area of the BS or to enhance the data delivery quality depending on its position and purpose. Depending on the intention of the BS operator, the RS can support functions under circumstances when it is installed in a specific building, or provide various functions such as insignificant handoff request when it is installed in a public transport.

Therefore, there is needed a procedure of negotiating an RS function with an upper node so that the RS can execute the function in accordance with its position and purpose.

### SUMMARY OF THE INVENTION

An aspect of the present invention is to substantially solve at least the above problems and/or disadvantages and to provide at least the advantages below. Accordingly, an aspect of the present invention is to provide an apparatus and method for adopting a multihop relay scheme in a BWA communication system.

Another aspect of the present invention is to provide an apparatus and method for informing a serving station of function information supportable by the RS, which executes an initial access procedure in a multihop relay BWA communication system.

A further aspect of the present invention is to provide an apparatus and method of negotiating a function to be provided by an RS with a serving station in a multihop relay BWA communication system.

The above aspects are achieved by providing a method for negotiating a relay service function of an RS in a multihop relay BWA communication system, including transmitting, at the RS, a first message containing function information supportable by the RS to a serving station, confirming, at the serving station, the RS supportable function using the first message received from the RS, transmitting, at the serving station, a second message containing relay service function information to be performed by the RS to the RS, the relay service function determined by considering the RS supportable function, and executing, at the RS, the relay service according to the RS service information of the second message.

According to the present invention, an RS in a multihop relay BWA communication system includes a message generator for generating a first message which contains supportable relay service function information, a message processor for confirming a relay service to support from a second message which is received from a serving station containing relay service function information, and an interface module for transmitting the first message to the serving station and receiving the second message from the serving station.

According to the present invention, a serving station in a multihop relay BWA communication system includes a message processor for confirming functions supportable by an RS from a first message received from the RS, a relay service determiner for determining a relay service to be supported by the RS by considering the supportable functions of the RS, a message generator for generating a second message containing relay service information to be supported by the RS, and an interface module for receiving the first message from the RS and transmitting the second message to the RS.

According to the present invention, an apparatus for negotiating a relay service function in a multihop relay BWA communication system includes an RS for transmitting a first message containing supportable relay service information to a serving station, acquiring relay service information to be performed from a second message received from the serving station, and executing the relay service, and the serving station for transmitting to the RS the second message containing the relay service function information to be performed by the RS using the RS supportable relay service information of the first message.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a conventional IEEE 802.16e communication system;

FIG. 2 illustrates a conventional multihop relay broadband wireless communication system for the serving area extension;

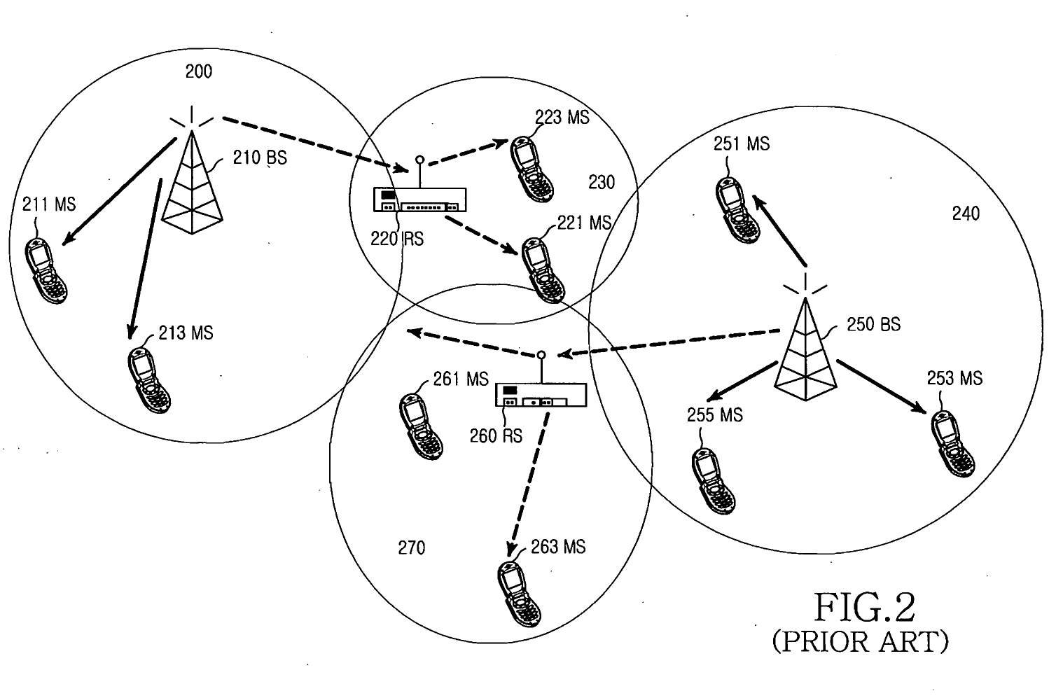

FIG. 3 illustrates a conventional multihop relay BWA communication system for increased system capacity;

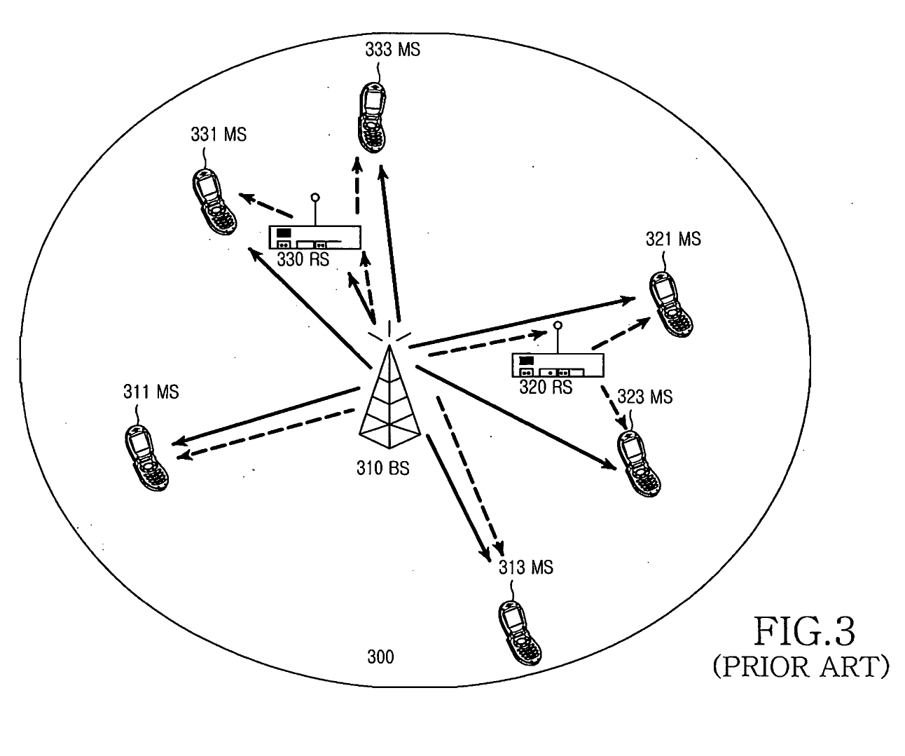

FIG. 4 illustrates an application of an RS based on an RS function type in a multihop relay BWA communication system according to the present invention;

FIG. 5 illustrates an RS function negotiation procedure in the multihop relay BWA communication system according to the present invention; and

FIG. 6 illustrates the RS function negotiation in the multihop relay BWA communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

The present invention provides a technique of negotiating a relay service to be supported by an RS (Relay Station) with a serving station in a multihop relay BWA (Broadband Wireless Access) communication system. Specifically, the present invention provides the technique for the RS initially accessing to negotiate relay service with the serving station in the BWA communication system. While the negotiation between a BS and the RS is illustrated by way of example, the present invention is applicable to the negotiation between an upper RS and a lower RS.

Also, the BWA communication system adopts an OFDM or OFDMA scheme by way of example. Hence, using the OFDM/OFDMA scheme, the BWA communication system can achieve high-speed data transmission by transmitting physical channel signals using a plurality of subcarriers and support mobility of the MS by virtue of multicell architecture.

While the BWA communication system is explained as an example, the present invention is applicable to multihop relay cellular communication systems.

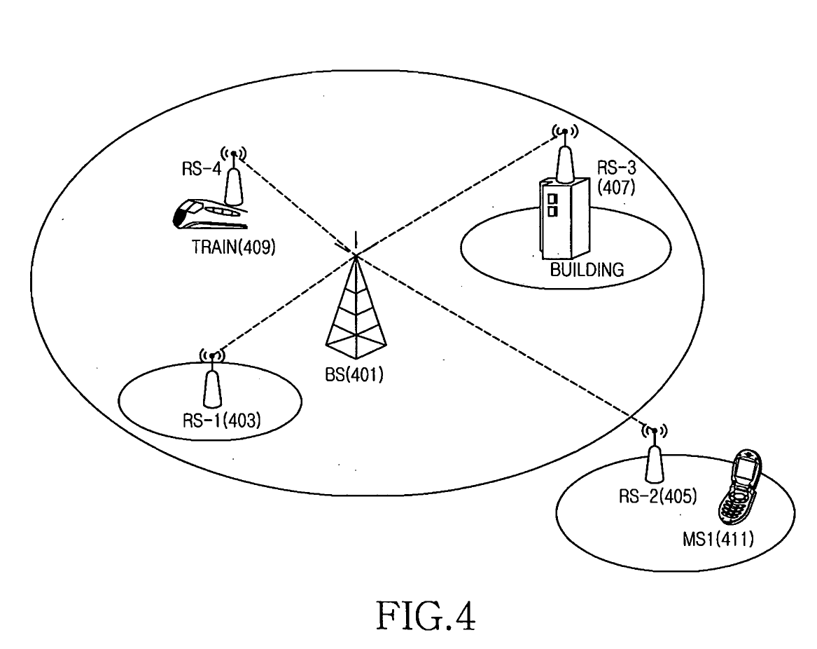

FIG. 4 illustrates an application of an RS based on an RS function type in a multihop relay BWA communication system according to the present invention.

In FIG. 4, BS 401 provides service to MSs via RSs 403, 405, 407 and 409, which RSs provide diverse functions according to their positions and purposes.

The RS-1 403 is able to communicate directly with the BS 401 and is used to enhance quality of data transmission of an MS that suffers signal interference against buildings or a poor channel state due to its position close to the boundary of the service area of the BS 401.

The MS serviced via the RS-1 403 can communicate directly with the BS 401. Accordingly, the RS-1 403 relays unicast traffic transceived between the BS 401 and the MS. In this case, the MS transmits and receives control messages directly with the BS 401.

The RS-2 405 functions to provide services to MSs outside the service area of the BS 401. Namely, the BS 401 can expand its service area using the RS-2 405.

MS 411 outside the service area of the BS 401 communicates with the BS 401 via the RS-2 405 because its signal transmission and reception with the BS 401 is not possible. Thus, the RS-2 405 relays not only traffic but also control information transceived between the BS 401 and the MS 411.

In other words, the RS-2 405 needs to provide ranging function, function negotiation, authentication, registration, and operational parameter transmission with the MS 411, instead of the general functions of the BS.

The RS-3 407 is installed in a building to provide relay services to MSs traveling within the building. The RS-3 407 relays the transceived signals of the BS 401 in the manner of the RS-1 406 and the RS-2 405, whereas the RS-3 407 may provide a different environment depending on requirements of a service provider. Specifically, unlike the RS-1 406 and the RS-2 405, the RS-3 407 services MSs indoors and is subject to the spatial limitation and the limited number of users due to the building size. In short, the RS-3 407 can provide the relay service only within the building where the RS-3 407 is installed.

As above, the positions or the MSs serviced by the RS-3 407 may differ from the RS-1 403 and the RS-2 405, and the functions supported by the RS-3 407 may differ according to the service provider's requirements.

The RS-4 409 is installed in a mobile transport such as train or bus to provide relay services for signals transceived between MSs in the vehicle and the BS 401. Accordingly, the RS-4 409 requires frequent mobility, and the number of objects to be relay-serviced; that is, the number of MSs is restricted and variable according to size and type of the transport means. Hence, the RS-4 409 cannot have the same values of relay service set elements such as mobility supportability, mobility characteristic and the number of serviced MSs, as the RS-1 403, the RS-2 405 and the RS-3 407.

As explained above, the relay service function and type to be supported by the RS differ depending on the position and the service support aim of the RS. Therefore, the BWA communication system negotiates relay service of the RS with the BS when the RS executes an initial access procedure negotiation with the BS. In the initial access procedure negotiation, when the RS reports its supportable functions to the BS, the BS determines a function of the RS by examining the RS's supportable functions and informs the determined function to the RS.

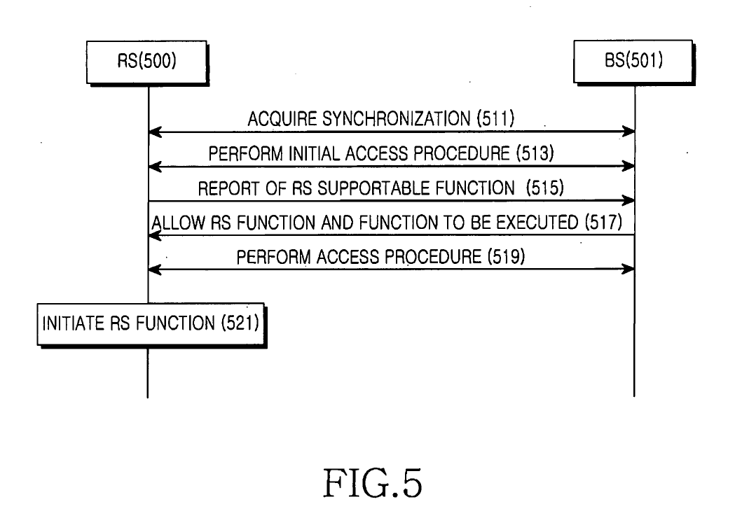

FIG. 5 illustrates an RS function negotiation procedure in the multihop relay BWA communication system according to the present invention.

In FIG. 5, the RS 500, which is turned on, determines the BS 501 as a serving BS, receives a preamble from the BS 501 and acquires system synchronization with the BS 501 in step 511. Next, the RS 500 performs an initial access procedure through the ranging with the BS 501 in step 513.

To execute an RS service capability negotiation with the BS 501, the RS 500 transmits RS supportable function information to the BS 501 in step 515. The RS supportable function information message is transmitted using a message for the access procedure such as MS-Basic-Capability (SBC) message or registration message. For instance, the RS supportable function information message contains the following contents as shown in Table 1.

TABLE 1

| Field (bit) | Content |
|---|---|
| 1 | preamble generation/transmission function |
| 1 | MS ranging processing function |
| 1 | CID self allocation function |
| 1 | neighbor BS information advertisement message regeneration, |
| | transmission function |
| 1 | neighbor BS information acquisition, neighbor BS information |
| | list managing function |
| 1 | 2-hop or more multihop routing support function |
| 1 | MS registration request processing function |
| 1 | RS registration request processing function |
| 1 | MS handover support function |
| 1 | RS handover support function |
| 1 | DL data transmission scheduling support function |
| 1 | UL data transmission scheduling support function |
| 1 | RS mobility support function |
| 1 | service area characteristic indication (e.g., indoor, outdoor) |
| 1 | HARQ support function |
| 1 | Band AMC support function |

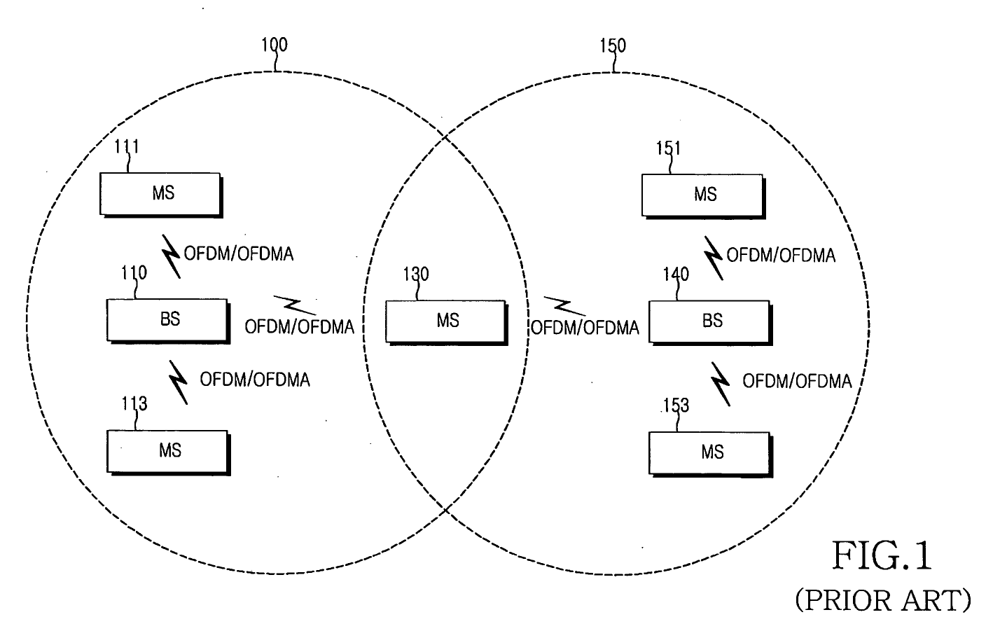

The RS supportable function information message contains the fields of the functions supportable by the RS as shown in FIG. 1. The preamble generation/transmission field is generated and used by the RS as a separate preamble different from the BS, and indicates whether the preamble can be broadcast to MSs in the relay region. The MS ranging processing function field indicates whether the RS can process a ranging request message received from the MS by itself.

The Connection IDentifier (CID) self-allocation function field indicates whether the CID is requested to the BS or the RS allocates the CID when the CID is to be allocated to the MS. When the CID is requested to the BS, the RS requests the CID for the MS to the BS and relays the CID allocated from the BS to the MS. When the RS itself allocates the CID, it allocates the CID directly to the MS using a certain portion of the CID allocated from the BS.

The CID self-allocation field also indicates whether the RS can manage a CID table.

The neighbor BS information advertisement message regeneration transmission support function indicates whether to support a relay function to the MS by modifying or regenerating a neighbor BS information message received from the BS. The neighbor BS information message contains information of neighbor BSs, which is periodically broadcast over the service area by the serving BS.

The neighbor BS information acquisition and management function indicates whether the RS can acquire and manage the neighbor BS information through scanning. The 2-hop or more multihop routing function support field indicates whether the RS supports the RS-RS routing function between the BS and the MS by way of more than two RSs in the multihop relay structure.

The MS registration request processing function field indicates whether the RS itself can process a registration request message received from the MS. The RS registration request processing field indicates whether registration requests received from other RSs can be processed in the 2-hop or more multihop relay environment. If the RS cannot process the registration request messages of the other RSs, it should retransmit the registration request signals to the BS so that the BS processes the signals.

The MS handover support field indicates whether the RS supports handover of the MS. Specifically, the MS handover support field indicates whether the RS supports the handover when an MS serviced by the RS migrates to other coverage or an MS serviced in other coverage enters the relay region of the RS. The RS handover support field indicates whether the RS supports the handover of a lower RS supported by the RS.

The DownLink (DL) data transmission scheduling field indicates whether the RS itself can perform the scheduling to transmit a signal to the MS. In detail, the DL data transmission scheduling field indicates whether the RS itself can schedule a time point to transmit a DL signal received from the BS to the MS. If the RS cannot execute the self scheduling, it transmits the DL signal to the MS at a time point preset by the BS.

The UpLink (UL) data transmission scheduling field indicates whether the RS can perform the scheduling to transmit a UL signal of the MS communicating with the BS via the RS. Specifically, the UL data transmission scheduling field indicates whether the RS can schedule a bandwidth for the UL signal transmission of the MS and a transmission time point of the UL signal.

The Hybrid Automatic Repeat reQuest (HARQ) support field indicates whether the RS retransmits data. The band Adaptive Modulation and Coding (AMC) support field indicates whether the RS can apply an AMC scheme according to the channel condition of the frequency band.

The above information fields indicate the functions implemented at the RS. The supportable function information message can contain information relating to the characteristic and function information of the RS.

For instance, to indicate the characteristic information of the RS, the RS supportable function information message includes an RS mobility support function field indicating whether the RS is mobile, and a service area characteristic indication field indicating whether the position of the RS supports an indoor or outdoor MS.

Each field of the RS supportable function information messages as shown in Table 1 can indicate the RS's service supportability using 1 bit.

When the RS sends the RS supportable function information message of Table 1 to the BS, this message, which reports of the detail functions of the RS, occupies a large band due to its size. To reduce the band waste, the RS can construct the RS supportable function information message as shown in Table 2.

TABLE 2

| | |
|---|---|
| Supportability (1 bit) | RS type (2 bits) |

| | | |
|---|---|---|
| 0 or 1 | 00 | Type 1 |
| | 01 | Type 2 |
| | 10 | Type 3 |
| | 11 | Type 4 |

As shown in Table 2, the RS supportable function information message contains predefined RS type information. For instance, the BS and the RS can set the preamble generation/transmission function, the MS ranging processing function, the neighbor BS ad message regeneration and transmission function and the MS handover support function as type 1. When the RS supports the function of the type 1, the supportability field of the RS support information message is set to the supportable value (0 or 1) and the RS type field is set to ‘00’.

Next, upon receiving the RS supportable function information message, the BS 501 checks the functions supportable by the RS 500 using the received message.

The BS 501 transmits a message including a relay service function to be supported by the RS 500 to the RS 500 by considering the checked supportable function, the position and the aim of the RS 500 in step 517. Herein, this message contains information as to whether the RS 500 performs the relay service and the relay service function to be executed. This message can be constructed as shown in Table 1 or Table 2. That is, the BS 501 can indicate the supportability by generating the function fields of the RS 500 as shown in Table 1. Also, the BS 501 can indicate whether a specific combination is used according to the agreement between the RS 500 and the BS 501.

Upon receiving the message containing the information as to whether the relay service is performed and the relay service function to be performed from the BS 501, the RS 500 performs an access procedure required for the communication with the BS 501 in step 519.

Next, when the communication between the RS 500 and the BS 501 is initiated, the RS 500 commences the relay service function negotiated with the BS 501 in step 521.

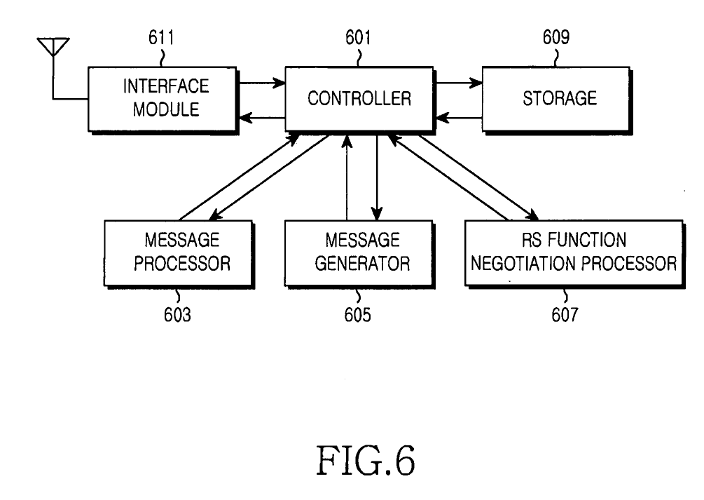

Herein, the block diagram of the RS and the BS for negotiating the relay service to be supported by the RS in the BWA communication system is described. The RS and the BS, which include the same interface module (communication module) in the BWA communication system, have the same block diagrams. Hence, the structures of the RS and the BS are now explained with reference to FIG. 6.

FIG. 6 illustrates the RS function negotiation in the multihop relay BWA communication system according to the present invention.

In the RS of FIG. 6, a controller 601 controls overall operation of the RS. For instance, the controller 601 processes and controls voice call and data communications, and processes the RS function negotiation related operation. More specifically, the controller 601 provides a message processor 603 with the control message received from the BS for the RS function negotiation with the RS. In addition, the controller 601 provides a message fed from a message generator 605 to an interface module 611 to transmit it to the BS.

The message processor 603 decomposes the control message received from the BS and informs the controller 601 of the result. For instance, the message processor 603 confirms the control message containing information as to whether to perform the relay service and the relay service function to be performed from the message of Table 1 or Table 2 received from the BS, and then provides the control information to the controller 601. The controller 601 controls an RS function negotiation processor 607 according to the control information fed from the message processor 603.

The message generator 605 generates an RS supportable function report message of Table 1 or Table 2 to transmit it to the BS under the control of the controller 601. The message generated at the message generator 605 is fed to the interface module 611 via the controller 601.

The RS function negotiation processor 607 provides the controller 601 with information for the communications with the BS in accordance with the RS function information parameters under the control of the controller 601.

A storage 609 stores programs required to control the overall operation of the node and temporary data generated in the program execution. That is, the storage 609 can generally store data and control information to transmit from the RS to the BS. When the message of Table 2 is transceived with the BS, the storage 609 stores a function combination table set with the BS in advance.

The interface module 611 functions to communicate with the BS and includes an RF processor and a baseband processor.

The RF processor converts a signal received over an antenna to a baseband signal and provides the baseband signal to the baseband processor. The RF processor converts a baseband signal fed from the baseband processor to an RF signal transmittable over the air and transmits the RF signal over the antenna.

The baseband processor Fast Fourier Transform (FFT)-processes and channel-decodes the signal fed from the RF processor and provides the original information data to the controller 601. The baseband processor channel-codes and Inverse FFT (IFFT)-processes data fed from the controller 601 and provides the processed data to the RF processor.

In the BS of FIG. 6, a controller 601 controls overall operation of the BS. For instance, the controller 601 processes and controls voice call and data communications, and processes the RS function negotiation related operation. More specifically, the controller 601 provides a message processor 603 with the control message received from the RS for the RS function negotiation with the RS. In addition, the controller 601 provides a message fed from a message generator 605 to an interface module 611 to transmit it to the RS.

The message processor 603 decomposes the control message received from the RS and informs the controller 601 of the result. For instance, upon receiving the RS supportable function report message of Table 1 or Table 2 from the RS, the message processor 603 extracts all control information from the received message and provides the extracted information to the controller 601.

The message generator 605 generates a message to transmit to the RS under the control of the controller 601. For instance, the message generator 605 generates a message containing information as to whether to perform the relay service of the RS and the relay service function to execute as shown in Table 1 or Table 2 under the control of the controller 601.

The RS function negotiation processor 607 manages RSs executing the RS function negotiation procedure under the control of the controller 601. The RS function negotiation processor 607 sets a function to be supported by the RS according to the function information supportable by the RS, which is fed from the controller 601, the RS position and the relay service support aim.

A storage 609 stores programs required to control the overall operation of the BS and temporary data generated in the program execution. That is, the storage 609 can generally store data and control information to transmit to the RS. When the message of Table 2 is transceived with the RS, the storage 609 stores a function combination table set with the BS in advance.

The interface module 611 functions to communicate with the RS and includes an RF processor and a baseband processor.

The RF processor converts a signal received over an antenna to a baseband signal and provides the baseband signal to the baseband processor. The RF processor converts a baseband signal fed from the baseband processor to an RF signal transmittable over the air and transmits the RF signal over the antenna.

The baseband processor FFT-processes and channel-decodes the signal fed from the RF processor and provides the original information data (traffic or control message) to the controller 601.

The baseband processor channel-codes and IFFT-processes data fed from the controller 601 and then provides the processed data to the RF processor.

In the RS and the BS as constructed above, the controller 601 controls the message processor 603, the message generator 605 and the RS function negotiation processor 607. Herein, the controller 601 can function as the message processor 603, the message generator 605 and the RS function negotiation processor 607. Those components are separately illustrated to distinguish their functions. In the implementation, all or part of the message processor 603, the message generator 605 and the RS function negotiation processor 607 can be processed at the controller 601.

As set forth above, in the multihop relay BWA communication system, a node supporting the relay service function performs the relay service function negotiation with its upper node. Advantageously, the node supporting the relay service can provide the signaling process to determine the relay service function to execute, and the BS can recognize the relay service functions supportable by the node supporting the relay service and the characteristic information.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for negotiating a relay service function of a Relay Station (RS) in a multihop relay wireless communication system, the method comprising:
transmitting, at the RS, a first message including function information supportable by the RS to a serving station;
confirming, at the serving station, the RS supportable function using the first message received from the RS;
transmitting, at the serving station, a second message including relay service function information to be performed by the RS to the RS, the relay service function being determined by considering the RS supportable function; and
executing, at the RS, the relay service according to the RS service information of the second message.

2. The method of claim 1, wherein the first message and the second message include at least one function of a preamble generation/transmission function, a mobile station (MS) ranging processing function, a Connection IDentifier (CID) set allocation function, a neighbor Base Station (BS) information advertisement message regeneration and transmission function, a neighbor BS information acquisition and neighbor BS information list managing function, a 2-hop or more multihop routing support function, an MS registration request processing function, an RS registration request processing function, an MS handover support function, an RS handover support function, a DownLink (DL) data transmission scheduling support function, an UpLink (UL) data transmission scheduling support function, an RS mobility support function, a service area characteristic indication function, a Hybrid Automatic Repeat reQuest (HARQ) support function and a band Adaptive Modulation and Coding (AMC) support function.

3. The method of claim 1, wherein the first message is formed using a number of fields indicating respective functions supportable by the RS, or using combinations including a number of functions.

4. The method of claim 1, wherein the second message is formed using a number of fields indicating respective functions to be executed by the RS, or using combinations including a number of functions.

5. The method of claim 1, further comprising:
acquiring, at the RS, system synchronization with the serving station and performing an initial ranging procedure,
wherein the RS transmits the first message to the serving station after the initial ranging.

6. The method of claim 1, wherein the serving station is either a BS or an upper RS.

7. A Relay Station (RS) in a multihop relay wireless communication system, comprising:
a message generator for generating a first message which includes supportable relay service function information;
a message processor for confirming a relay service to support from a second message which is received from a serving station including relay service function information; and
an interface module for transmitting the first message to the serving station and receiving the second message from the serving station.

8. The RS of claim 7, wherein the first message and the second message include at least one function of a preamble generation/transmission function, a Mobile Station (MS) ranging processing function, a Connection IDentifier (CID) set allocation function, a neighbor Base Station (BS) information advertisement message regeneration and transmission function, a neighbor BS information acquisition and neighbor BS information list managing function, a 2-hop or more multihop routing support function, an MS registration request processing function, an RS registration request processing function, an MS handover support function, an RS handover support function, a DownLink (DL) data transmission scheduling support function, an UpLink (UL) data transmission scheduling support function, an RS mobility support function, a service area characteristic indication function, a Hybrid Automatic Repeat reQuest (HARQ) support function and a band Adaptive Modulation and Coding (AMC) support function.

9. The RS of claim 7, wherein the message generator includes the first message using a number of fields indicating respective functions supportable by the RS, or using combinations including a number of functions.

10. The RS of claim 7, wherein the message processor processes the second message, which is formed using a number of fields indicating respective functions to be executed by the RS, or using combinations including a number of functions.

11. The RS of claim 7, wherein the serving station is either a Base Station (BS) or an upper RS.

12. A serving station in a multihop relay wireless communication system, comprising:
a message processor for confirming functions supportable by a Relay Station (RS) from a first message received from the RS;
a relay service determiner for determining a relay service to be supported by the RS by considering the supportable functions of the RS;
a message generator for generating a second message including relay service information to be supported by the RS; and
an interface module for receiving the first message from the RS and transmitting the second message to the RS.

13. The serving station of claim 13, wherein the message includes at least one function of a preamble generation/transmission function, a Mobile Station (MS) ranging processing function, a Connection IDentifier (CID) set allocation function, a neighbor Base Station (BS) information advertisement message regeneration and transmission function, a neighbor BS information acquisition and neighbor BS information list managing function, a 2-hop or more multihop routing support function, an MS registration request processing function, an RS registration request processing function, an MS handover support function, an RS handover support function, a DownLink (DL) data transmission scheduling support function, an UpLink (UL) data transmission scheduling support function, an RS mobility support function, a service area characteristic indication function, a Hybrid Automatic Repeat reQuest (HARQ) support function and a band Adaptive Modulation and Coding (AMC) support function.

14. The serving station of claim 12, wherein the message processor processes the first message which is formed using a number of fields indicating respective functions supportable by the RS, or using combinations including a number of functions.

15. The serving station of claim 12, wherein the message generator forms the second message using a number of fields indicating respective functions supportable by the RS, or using combinations including a number of functions.

16. The serving station of claim 12, wherein the serving station is either a Base Station (BS) or an upper RS.

17. An apparatus for negotiating a relay service function in a multihop relay wireless communication system, comprising:
a Relay Station (RS) for transmitting a first message including supportable relay service information to a serving station, acquiring relay service information to be performed from a second message received from the serving station, and executing the relay service; and
the serving station for transmitting to the RS the second message including the relay service function information to be performed by the RS using the RS supportable relay service information of the first message.

18. The apparatus of claim 17, wherein the first message and the second message include at least one function of a preamble generation/transmission function, a Mobile Station (MS) ranging processing function, a Connection IDentifier (CID) set allocation function, a neighbor Base Station (BS) information advertisement message regeneration and transmission function, a neighbor BS information acquisition and neighbor BS information list managing function, a 2-hop or more multihop routing support function, an MS registration request processing function, an RS registration request processing function, an MS handover support function, an RS handover support function, a DownLink (DL) data transmission scheduling support function, an UpLink (UL) data transmission scheduling support function, an RS mobility support function, a service area characteristic indication function, a Hybrid Automatic Repeat reQuest (HARQ) support function and a band Adaptive Modulation and Coding (AMC) support function.

19. The apparatus of claim 17, wherein the RS forms the first message using a number of fields indicating respective functions supportable by the RS, or using combinations including a number of functions.

20. The apparatus of claim 17, wherein the serving station forms the second message using a number of fields indicating respective functions to be performed by the RS, or using combinations including a number of functions.

21. The apparatus of claim 18, wherein the serving station is either a Base Station (BS) or an upper RS.
